(19) United States
(12) Patent Application Publication
(10) Pub. No.: US 2026/0295836 A1
(43) Pub. Date: Oct. 1, 2026

(54) METHOD AND SYSTEM FOR INCREASING THE ACCURACY WITH WHICH A PATH IS FOLLOWED BY A TOOL OF A ROBOT

(71) Applicants: AIRBUS (S.A.S.), Blagnac (FR); AIRBUS OPERATIONS (S.A.S.), Toulouse (FR); AIRBUS OPERATIONS GmbH, Hamburg (DE)

(72) Inventors: Matthias OTTO, Hamburg (DE); Boris MORINIERE, Rochefort (FR); Olivier BÜRGY, Toulouse (FR)

(21) Appl. No.: 19/578,387

(22) Filed: Mar. 25, 2026

(30) Foreign Application Priority Data
Mar. 26, 2025 (FR) FR2503096

(51) Int. Cl. B25J 9/16; B25J 9/02

(52) U.S. Cl. CPC B25J 9/1664; B25J 9/023; B25J 9/1653

(57) ABSTRACT

A method and system for increasing the accuracy with which a path is followed by a tool of a robot. The method includes a data-acquiring step, during which the robot executes the desired path without the tool performing the task that has been assigned to it and an inertial measurement device takes inertial measurements representative of small repeatable inaccuracies in the path, and an operating step during which the robot again executes the same path, the tool performs the task that has been assigned to it, and actuators are controlled to compensate for inaccuracies of the tool, while taking into account processing of said inertial measurements, carried out by a computing device, this making it possible to minimize small inaccuracies in path of small amplitudes of the tool, without having to act on the path of the robot, and thus to increase the accuracy with which a smooth path is followed.

### CROSS REFERENCE TO RELATED APPLICATION

This application claims priority to French Application Number FR 2503096, filed Mar. 26, 2025, the entire contents of which is hereby incorporated by reference.

### BACKGROUND

The present invention relates to a method and system for increasing the accuracy with which a path is followed by a tool of a robot.

Industrial robots, especially six-axis manipulators, are widely used in industry because of their great versatility, which is in particular due to their vast working space (six degrees of freedom) and also to their cost-effectiveness. However, these robots exhibit inaccuracies in respect of path that are repeated and correspond to residual errors made by the robot when following the path. In practice, these repeatable inaccuracies manifest themselves in the form of sinusoidal oscillations about the path to be followed by a tool of the robot.

Even though these repeatable inaccuracies are relatively small, they may affect the quality of a delicate task performed by the tool, such as DTS printing for example (DTS being the abbreviation of Direct-To-Shape), which is a printing technology for printing directly on the three-dimensional surface of an object, an airplane for example. In this case, the inability of the robot to perfectly follow a smooth path (namely a path for which velocity and acceleration are continuous functions of time) affects print quality. In particular, slight path inaccuracies of small amplitudes (less than 0.2 mm, and more specifically between 20 μm and 200 μm) may cause visible printing defects, thus decreasing print quality.

Various ways of reducing path inaccuracies are known. In particular, the following are known:
a method referred to as the “mirror path” method, in which the path is executed a first time, where the robot actually passes is measured by means of a laser tracker, and reference points on the path are modified slightly to obtain a corrected path that is then used. However, this method is only effective for large path inaccuracies, and not for small path inaccuracies (of a few tens of microns);
a method which is used specifically for printing applications, in which, successively, a target image is printed once on a part, the printed part is scanned, printing defects are detected, an image reference is modified to compensate for robot errors, and the modified image reference is printed on the final part;
a visual servo-control method. Although effective, this method requires a reference. Thus, when printing successive bands, it works well for printed bands starting from the second band, but not for the first band (for which there are not yet any printed marks for the servo-control).

None of these conventional solutions are therefore completely satisfactory for the envisioned applications.

Thus, there is a need to find a solution allowing small inaccuracies in the path of a robot when it is performing a delicate task on a smooth path, such as direct-to-shape printing for example, to be minimized.

### SUMMARY

The purpose of the present invention is to provide such a solution. To do this, it relates to a method for increasing the accuracy with which a smooth path is followed by a tool of a multi-joint robot.

According to the invention, said method comprises at least the sequence of the following steps:
a data-acquiring step, implemented by means of the robot, in which the robot is made to execute a path, referred to as the robot path, allowing the tool (in a non-operational situation) to follow a given smooth path, during which step values of inertial parameters are measured, by means of at least one inertial measurement device, and values of state data of the robot are determined, the measured values of the inertial parameters and the determined values of the state data being stored;
a data-processing step, implemented by a computing device, in which, based on the measured and stored values of the inertial parameters, on the determined and stored values of the state data, and on the given smooth path, a prediction model for predicting future values of the state data of the robot is formed; and
an operating step, implemented by means of the robot, in which the robot is made to execute said robot path, this second step of execution comprising a control sub-step in which, repeatedly, during execution of the robot path, actuators of the tool are controlled so as to compensate for Cartesian errors in order to increase the accuracy with which the tool (in an operational situation) follows said smooth path, said Cartesian errors being determined based on a predicted Cartesian path, obtained from said future values of the state data.

In the context of the present invention, what is meant:
by operational situation, is the situation in which the tool of the robot is controlled to perform the task that has been assigned to it, i.e. the task that it must perform in the application in question; and
by non-operational situation, is the situation in which the tool of the robot does not perform the task that has been assigned to it.

In addition, in the context of the present invention, what is meant:
by smooth path, is a path for which velocity and acceleration are continuous functions of time, allowing a continuous and jerk-free movement to be obtained; and
by robot path, is the path followed by the robot.

Thus, by virtue of the invention, the robot is first made to execute (in the data-acquiring step) the robot path without the tool performing the task that has been assigned to it, for example by keeping its actuators blocked, and inertial measurements representative of small (repeatable) path inaccuracies are taken, then in an operating step during which the robot is made to execute the same robot path again and during which the tool performs the task that has been assigned to it, actuators of the tool are controlled to compensate for inaccuracies in the path of the tool. This allows small inaccuracies (of small amplitudes) in the path of the tool of the robot to be minimized, without having to act on the (robot) path of the robot.

This method may be used in a variety of applications. In particular, it is well suited to minimizing slight path inaccuracies encountered during direct-to-shape printing.

In a first preferred embodiment, in the operating step, during execution of the robot path by the robot, values of inertial parameters are measured and values of state data of the robot are determined, the measured values of the inertial parameters and the determined values of the state data being stored in a (buffer) memory, the second step of execution also comprising at least the following sub-steps, which are implemented repeatedly:
a predicting sub-step in which, by means of said prediction model, future values of the state data in a future time window are predicted, based on past measured values of the inertial parameters and on past determined values of the state data, which are stored in the (buffer) memory;
a first computing sub-step in which, based on the predicted future values of the state data, the predicted Cartesian path that the robot will execute in the future time window is computed; and
a second computing sub-step in which, in a reference frame of the tool, said Cartesian errors of said predicted Cartesian path are computed with respect to the given smooth path, the actuators of the tool being controlled (in the control sub-step) to compensate for these Cartesian errors.

Moreover, advantageously, the second step of execution also comprises an extracting sub-step in which the past measured values of the inertial parameters and the past determined values of the state data are extracted from the (buffer) memory, which values will be used in the predicting sub-step.

Furthermore, in a second simplified embodiment, at least the predicted Cartesian path is formed in the data-processing step.

Moreover, advantageously, the prediction model formed in the data-processing step is based on one of the following elements: a regression, a neural network.

Furthermore, advantageously:
the inertial parameters comprise at least certain of the following parameters: one or more linear accelerations, one or more angular velocities; and/or
the state data comprises at least certain of the following data of the robot: one or more joint positions, one or more joint velocities, one or more Cartesian positions, one or more Cartesian velocities.

Moreover, advantageously, the method also comprises a programming step in which the robot is programmed to execute said robot path in such a way that the tool follows the smooth path.

The present invention also relates to a system for increasing the accuracy with which a smooth path is followed by a tool of a robot.

According to the invention, the system comprises at least:
said robot which is controlled to execute a path called the robot path allowing the tool to follow a given smooth path, the robot being controlled to execute a robot path both for a non-operational situation and for an operational situation of the tool;
at least one inertial measurement device configured to measure the values of inertial parameters during execution of the robot path by the robot, at least for said non-operational situation of the tool;
at least one memory configured to store the values of the inertial parameters measured by the inertial measurement device, and determined values of state data of the robot;
a computing device configured at least to form, based on the measured and stored values of the inertial parameters, on the determined and stored values of the state data, and on the given smooth path, a prediction model for predicting future values of the state data of the robot; and
actuators of the tool that are configured to compensate, during execution of the robot path in the operational situation of the tool, for Cartesian errors in order to increase the accuracy with which said smooth path is followed by the tool, said Cartesian errors being determined based on a predicted Cartesian path, obtained from said future values of the state data.

### BRIEF DESCRIPTION OF THE DRAWINGS

The appended figures will make it easy to understand how the invention may be implemented. In these figures, identical reference signs denote similar elements.

FIG. 1 is the block diagram of a method for increasing the accuracy with which a smooth path is followed by a tool of a robot.

FIG. 2 schematically shows a system configured to implement the method of FIG. 1.

FIG. 3 schematically illustrates one example of a robot capable of forming part of the system of FIG. 2.

### DETAILED DESCRIPTION

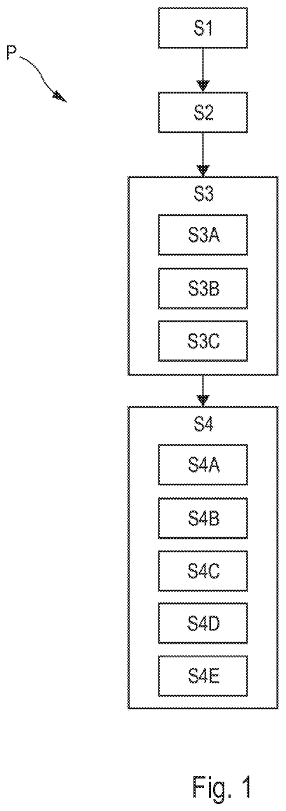

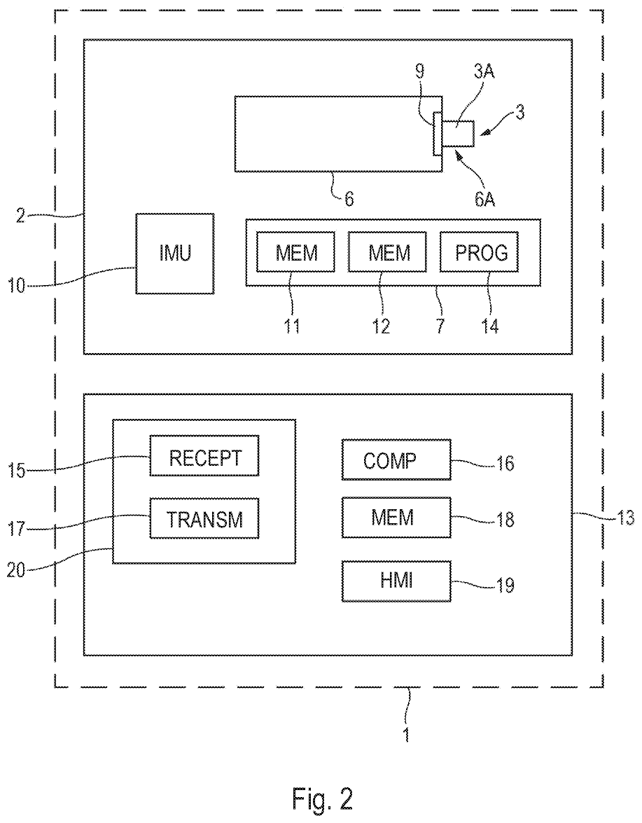

In the context of the present invention, a method P (one particular embodiment of which is for example shown in FIG. 1) capable of being implemented by a system 1 (one particular embodiment of which is for example shown in FIG. 2) is intended to increase the accuracy of a smooth path followed by a tool 3 of a staged multi-joint robot 2.

The multi-joint robot 2 comprises a plurality of joints (as described in more detail below) and a tool 3 (or effector), i.e. a part of the robot 2 that is generally located at one end of the robot 2 and that is intended to interact directly with its environment to accomplish a specific task. The tool 3 thus has mobility (generated by actuators) that is redundant to those of the robot 2 that bears the tool 3.

The axes of the robot 2 (which for example are six in number) allow large movements (required to achieve the desired range) but they generate path errors, while the axes of the tool 3 (which is borne by the robot 2 and therefore subjected to the movements of the robot 2) have a small range, but a high accuracy. The robot 2 is thus of staged type.

The system 1 may be applied to multi-joint robots 2 capable of being used in various applications, and more particularly in the industrial field, where it is sought to accurately control the (smooth) path followed by the tool 3 of the robot 2.

By way of illustration, the robot 2 may be used to implement direct-to-shape (DTS) printing, which is a printing technology for printing directly on the three-dimensional surface of an object, whatever its shape or texture, on the fuselage of an airplane for example. In this case, the robot 2 comprises, at a free end, as tool 3, a printing end-effector provided with a plurality of print heads.

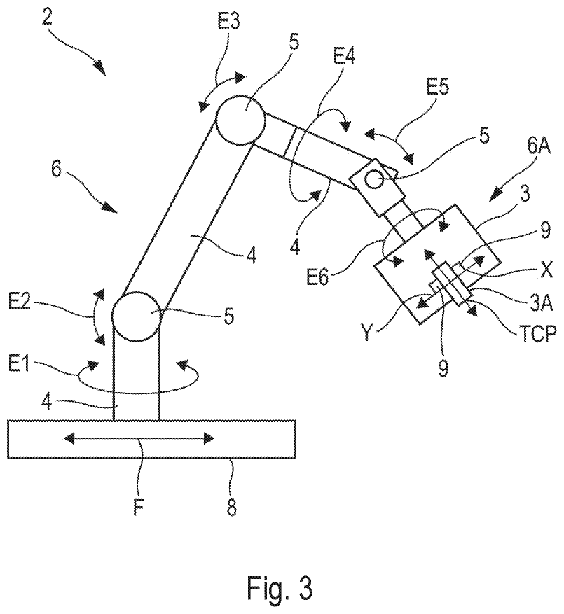

The robot 2 may be configured to make any type of movement (linear movement, rotary movement, complex articulation, etc.). To do this, it comprises, in the conventional way, a mechanical assembly 6 provided, in particular, with segments 4 (or arms) that are articulated at joints 5, as shown by way of illustration in FIG. 3. Each joint 5 may be controlled, in the conventional way, by an (electric, hydraulic or pneumatic) motor (not shown).

The robot 2 also comprises, as shown in FIG. 2, a control unit 7 intended, in particular, to control the movements of the robot 2, and generally the tasks performed by the tool 3 of the robot 2.

The robot 2 shown by way of illustration in FIG. 3 comprises a base 8 capable of being moved as illustrated by a double-headed arrow F and segments 4 articulated at the joints 5. This robot 2 may make movements illustrated by double-headed arrows E1, E2, E3, E4, E5 and E6. The robot 2 is provided with a tool 3 at a free end 6A of the mechanical assembly 6. This tool 3 is equipped with actuators 9 capable of moving at least one portion 3A of the tool 3 in the way illustrated by double-headed arrows X and Y (FIG. 3).

FIG. 3 also shows a TCP (abbreviation of Tool Center Point) which corresponds to a reference point of the portion 3A of the tool 3, that performs the task assigned to the tool 3, this reference point having to follow an exact smooth path.

The robot 2 thus comprises:
the mechanical assembly 6 (for example of six axes) which enables a large amplitude of movement (for example six degrees of freedom) but generally an accuracy having limits; and
actuators 9 of the tool 3, which are capable of providing additional (localized) mobility, with a view to positioning the TCP more precisely with respect to the mechanical assembly 6, as described in more detail below.

Industrial robots such as the robot 2 generally exhibit path inaccuracies that are repeatable. In practice, these repeatable inaccuracies may take the form of a sum of sinusoidal oscillations about the path in question, in every dimension. These inaccuracies are repeatable when the same robot path (same start point, same end point, same course) is followed by the same robot at the same velocity, with the same payload. For example, when a six-axis robot is programmed in such a way that the tool follows a path that is perfectly linear with respect to a fixed planar surface, it is generally possible to observe, on the path actually followed by the robot, a variation in the forward direction corresponding to variations in velocity and/or a variation in the transverse direction corresponding to residual errors made following the route and/or a variation in the orientation of the tool.

These repeatable inaccuracies typically have the following characteristics, especially in the case of direct-to-shape printing:
an amplitude of ±300 μm;
a frequency range of 2 to 10 Hz;
an acceleration of ±10 mm/s²; and
a velocity of rotation of ±0.5°/s.

Even though these repeatable inaccuracies are relatively small, they may affect the quality of the task performed by the tool 3 of the robot 2. For example, in the case of direct-to-shape printing, path inaccuracies of small amplitudes (less than or equal to 0.2 mm, and especially between 20 μm and 200 μm) lead to visible printing defects that decrease the quality of the print, such as marbling, graining, color misalignment and/or introduction of small white lines into areas of otherwise flat tint.

The aim of the system 1 is, in particular, to reduce such inaccuracies in the path of the tool 3 of the robot 2 performing a task (for example direct-to-shape printing) along a smooth path.

To do this, the system 1 in particular comprises, as shown in FIG. 2:
said robot 2, which is controlled to execute a robot path T1 allowing the tool 3 to follow a given smooth path T2, the robot 2 being controlled to execute the robot path T1 in a data-acquiring step S2 and in an operational step S4, which steps are described in detail below;
at least one inertial measurement device 10, for example an inertial measurement unit (IMU), mounted on the robot 2 and configured to measure values of inertial parameters during execution of the robot path T1 by the robot 2, at least in the data-acquiring step S2. The one or more inertial measurement devices 10 may be mounted on segments 4 of the robot 2 and also on the tool 3;
at least one memory 11, 12 (MEM), integrated for example into the control unit 7 of the robot 2 or into a processing unit (not shown) of the inertial measurement device 10, with a view to storing values of inertial parameters measured by the inertial measurement device 10, and values of state data 2 of the robot;
a computing device 13 configured at least to form, based on the measured and stored values of the inertial parameters, on the stored values of the state data, and on the given smooth path T2, a prediction model for predicting future values of the state data of the robot 2; and
the actuators 9 of the tool 3, which are configured to compensate, during execution of the robot path T1 in the operational step S4, for Cartesian errors in order to allow the tool 3 to follow said smooth path T2 with greater accuracy, said Cartesian errors being determined based on a predicted Cartesian path (obtained from said future values of the state data).

The purpose of the method P implemented by the system 1 is therefore to increase the accuracy with which the tool 3 of the robot 2 follows the smooth path T2 to be followed.

To this end, said method P in particular comprises, as shown in FIG. 1, the following steps, which are implemented by the system 1:
a programming step S1, implemented by means of a programming unit 14 (PROG) integrated into the control unit 7 of the robot 2 (FIG. 2), in which the robot 2 is programmed to execute the robot path T1 in such a way that the tool 3 follows the smooth path T2;
a data-acquiring step (or first step of execution) S2, implemented by means of the robot 2, in which the robot 2 is made to execute the robot path T1 as programmed, thus allowing the tool 3 (in a non-operational situation) to follow the given smooth path T2. During this execution of the robot path T1 by the robot 2, repeatedly, in each time increment in question (for example at a frequency of 250 Hz), values of inertial parameters are measured, by means of the inertial measurement device 10, and values of state data of the robot 2 are determined in a conventional way. The measured values of the inertial parameters and the determined values of the state data are stored, for example in the memory 11;
a data-processing step S3, implemented by the computing device 13, in which a (time series) prediction model for predicting future values of the state data of the robot 2 is formed, based on the measured and stored values of the inertial parameters, on the determined and stored values of the state data, and on the given smooth path T2; and
an operating step (or second step of execution) S4, implemented by means of the robot 2, in which the robot 2 is again made to execute the robot path T1. This operating step S4 comprises a control sub-step S4E in which, repeatedly in each time increment in question (for example at a frequency greater than 100 Hz), during execution of the robot path T1, the (local) actuators 9 of the tool 3 are controlled to compensate for Cartesian errors in order to allow the tool 3 (in operational situation) to follow the smooth path T2 with greater accuracy. The Cartesian errors are determined based on a predicted Cartesian path, obtained from said future values of the state data, as indicated below.

In the context of the present invention, what is meant:
by operational situation, is the situation in which the tool 3 of the robot 2 is controlled, for example by means of the control unit 7, to perform the task that has been assigned to it, i.e. the task that it must perform in the application in question. By way of example, in the context of direct-to-shape printing, as described above, the printing end-effector prints; and
by non-operational situation, is the situation in which the tool 3 of the robot 2 does not perform the task that has been assigned to it. For example, in the case of direct-to-shape printing, the printing end-effector does not print.

The various steps of the method P will now be described in more detail.

In the programming step S1, an operator programs the robot 2 in a conventional way, by means of the programming unit 14 (FIG. 2), so that it executes the robot path T1 in such a way that the tool 3 follows the desired smooth path T2.

In the context of the present invention, what is meant by smooth path is a path T2 combining the following three criteria:
the function describing the path, for example of six degrees of freedom (three translations, three rotations), is differentiable at least three times with respect to time;
the instantaneous acceleration is negligible compared to the acceleration due to gravity; and
the centripetal acceleration induced by a curvature of the path (and a given velocity of movement) is negligible compared to the acceleration due to gravity. By negligible what is meant is an acceleration that is low with respect to the acceleration due to gravity.

Next, in the data-acquiring step S2, the robot 2 is controlled (in the usual way), in particular by the control unit 7, to execute the robot path T1, allowing the tool 3 to follow the given smooth path T2. In this data-acquiring step S2, the tool 3 is in a non-operational situation and therefore does not perform the task that has been assigned to it.

During this execution of the robot path T1 by the robot 2, the inertial measurement device 10 measures values of inertial parameters, namely the values of one or more linear accelerations and/or the values of one or more angular velocities of the tool 3.

In addition, during this execution of the robot path T1, values of state data of the robot 2 are determined in a conventional way. The state data comprise at least certain of the following data of the robot 2:
one or more positions of the joints 5 (FIG. 3) of the mechanical assembly 6 of the robot 2, expressed for example in terms of values of angles in the directions of rotation illustrated by the double-headed arrows E1 to E6 in FIG. 3;
one or more joint velocities, each corresponding to the velocity at which the joint 5 in question is moving;
one or more Cartesian positions representing the spatial position or positions of the tool in a Cartesian coordinate system; and
one or more Cartesian velocities representing the velocity or velocities of movement of the tool in the Cartesian coordinate system.

The measured values of the inertial parameters and the determined values of the state data are stored in the memory 11.

The system 1 uses a conventional direct kinematic model allowing the position and orientation of the tool 3 to be expressed as a function of data (positions, velocities) relating to the joints 5 of the robot 2.

The following data-processing step S3 comprises:
a receiving sub-step S3A, implemented by a receiving unit 15 (RECEPT) of the computing device 13 (FIG. 2), in which at least the measured values of the inertial parameters and the determined values of the state data that were stored in the memory 11 are received. The computing device 13 may receive these data, for example by means of a file that is loaded into the computing device 13 or via transmission of data between the control unit 7 of the robot 2 and the receiving unit 15 of the computing device 13;
a computing sub-step S3B, implemented by a computing unit 16 (COMP) of the computing device 13, in which a (time series) prediction model for predicting future values of the state data of the robot 2 is formed, based on the measured and stored values of the inertial parameters, on the determined and stored values of the state data, and on the given smooth path T2; and
a transmitting sub-step S3C, implemented by a transmitting unit 17 (TRANSM) of the computing device 13, in which the (time series) prediction model or the future values of the state data of the robot 2 are transmitted to the control unit 7 of the robot 2.

In the computing sub-step S3B, the computing unit 16 may use various types of conventional models to obtain a parametric (prediction) model, and in particular a regression or a pre-trained neural network.

In the following operating step S4, the robot 2 is again made to execute the same robot path T1 (which is programmed). In this operating step S4, unlike the data-acquiring step S2, the tool 3 of the robot 2 is in an operational situation and is controlled, for example by means of the control unit 7, to perform the task that has been assigned to it.

This operating step S4 comprises a control sub-step S4E in which, repeatedly in each time increment in question (for example at a frequency greater than 100 Hz), during execution of the robot path T1, the actuators 9 of the tool 3 are controlled to compensate for Cartesian errors in order to allow the tool 3 to follow the smooth path T2 with greater accuracy.

In a (preferred) first embodiment, in the operating step S4, during execution of the robot path T1 by the robot 2, values of inertial parameters are measured by means of the inertial measurement device 10 and values of state data of the robot are determined in a conventional way. The measured values of the inertial parameters and the determined values of the state data are stored in the memory 12 (preferably a buffer memory).

The operating step S4 also comprises the following sub-steps, in which operations are performed repeatedly (for example at a frequency below 100 Hz):
an extracting sub-step S4A in which the values of the inertial parameters measured in the past and the values of the state data determined in the past, in a past time window, are extracted from the (buffer) memory 12. By way of example, at a time t, the past time window may be defined as follows: [t−0.5 s, t];
a predicting sub-step S4B in which, by means of said prediction model, future values of the state data in a future time window are predicted, based on past measured values of the inertial parameters and on past determined values of the state data, stored in the (buffer) memory 12 and extracted in the extracting sub-step S4A. For example, at a time t, the future time window may be defined as follows: [t, t+0.5 s];
a computing sub-step S4C in which, based on the predicted future values of the state data, the predicted Cartesian path that the robot 2 will execute in the future time window is computed; and
a computing sub-step S4D in which, in a reference frame (of the tool 3), said Cartesian errors (along at least one axis) of said predicted Cartesian path are computed with respect to the given smooth path T2.

The actuators 9 of the tool 3 are controlled, repeatedly, in the control sub-step S4E to compensate locally for the Cartesian errors (computed in the computing sub-step S4D), this allowing the tool 3 (and more particularly the TCP) to follow the smooth path T2 with greater accuracy.

This first embodiment, which, during the operating step S4, takes into account data obtained during execution of the part of the path already executed during this operating step S4, therefore uses real data (i.e. data representative of the actual operating state of the robot), this making it possible to increase the accuracy of the compensation carried out by means of the actuators 9 and thus the accuracy with which the smooth path T2 is followed by the tool 3.

Moreover, in a simplified second embodiment, the predicted Cartesian path is formed in the computing sub-step S3B of the data-processing step S3.

The Cartesian errors (along at least one axis) of this predicted Cartesian path, with respect to the given smooth path T2, are then computed. In this second embodiment, these Cartesian errors are computed, preferably, in the data-processing step S3, and they are used in the control sub-step S4E of the operating step S4 to control the actuators 9, repeatedly, in order to compensate for these Cartesian errors locally. In one variant of embodiment, the Cartesian errors may also be computed in the operating step S4.

This second embodiment, in which the Cartesian path is computed in the data-processing step S3, does not require inertial measurements to be taken in the operating step S4 and thus simplifies implementation of this operating step S4 and therefore of the method P.

As indicated above, the axes of the robot 2 allow large movements, but they are liable to generate path errors, while the axes of the tool 3 have a small range, but a high accuracy. Thus, in the method P:
in the data-acquiring step S2, the axes of the tool 3 are blocked; and
in the operating step S4, the axes of the tool 3 are controlled to compensate for the errors of the axes of the robot 2.

Moreover, the computing device 13 may also comprise, as shown in FIG. 2:
at least one memory 18 (MEM) capable of storing data that are used for the data-processing and computing operations implemented by the computing device 13, such as, for example, the measured values of the inertial parameters and the determined values of the state data; and
a human-machine interface 19 (HMI) allowing an operator to supply data to the computing device 1, such as, for example, the measured values of the inertial parameters and the determined values of the state data.

In addition, the receiving unit 15 and the transmitting unit 17 may form part of a conventional communication system 20 allowing the computing device 13 to communicate with devices external to said computing device 13, and in particular with the control unit 7 of the robot 2, via a wired or non-wired link. Furthermore, the computing unit 16 of the computing device 13 may correspond to any type of processor capable of implementing the corresponding processing and computing operations.

The system 1 therefore uses inertial measurements to identify, in real time, path inaccuracies, of small amplitudes, and then applies a command to actuators 9 of the tool 3 to minimize the effect of these inaccuracies and thus make it so that the tool 3 follows a smooth path with greater accuracy.

The method P and the system 1, as described above, thus make it possible to compensate, in a particularly efficient manner, for repeatable path inaccuracies that affect the tools of the robots. To do this, the path followed is not modified (in the operating step S4 during which the task assigned to the tool 3 is performed) but the position of the tool 3 is corrected so as to compensate for Cartesian errors corresponding to these repeatable inaccuracies.

The method P and the system 1 thus allow the smooth path T2 (which must be followed by the tool 3 of the robot 2) to be followed with greater accuracy. Thus, particularly when the method P and the system 1 are used for direct-to-shape printing, they make it possible to obtain a better print quality

1. A method for increasing the accuracy with which a smooth path is followed by a tool of a robot, comprising:
a data-acquiring step, implemented by means of the robot, in which the robot is made to execute a path, referred to as the robot path, allowing the tool in a non-operational situation to follow a given smooth path, during which step values of inertial parameters are measured, by means of at least one inertial measurement device, and values of state data of the robot are determined, the measured values of the inertial parameters and the determined values of the state data being stored;
a data-processing step, implemented by a computing device, in which, based on the measured and stored values of the inertial parameters, on the determined and stored values of the state data, and on the given smooth path, a prediction model for predicting future values of the state data of the robot is formed; and
an operating step, implemented by means of the robot, in which the robot is made to execute said robot path, this operating step comprising a control sub-step in which, repeatedly, during execution of the robot path, actuators of the tool are controlled so as to compensate for Cartesian errors in order to increase the accuracy with which the tool in an operational situation follows said smooth path, said Cartesian errors being determined based on a predicted Cartesian path, obtained from said future values of the state data.

2. The method as claimed in claim 1, wherein at least the predicted Cartesian path is formed in the data-processing step.

3. The method as claimed in claim 1, wherein, in the operating step, during execution of the robot path by the robot, values of inertial parameters are measured and values of state data of the robot are determined, the measured values of the inertial parameters and the determined values of the state data being stored in a memory, the operating step also comprising at least the following sub-steps, which are implemented repeatedly:
a predicting sub-step in which, by means of said prediction model, future values of the state data in a future time window are predicted, based on past measured values of the inertial parameters and on past determined values of the state data, which are stored in the memory;
a first computing sub-step in which, based on the predicted future values of the state data, the predicted Cartesian path that the robot will execute in a future time window is computed; and
a second computing sub-step in which, in a reference frame of the tool, said Cartesian errors of said predicted Cartesian path are computed with respect to the given smooth path, the actuators of the tool being controlled to compensate for these Cartesian errors.

4. The method as claimed in claim 3, wherein the operating step comprises an extracting sub-step in which the past measured values of the inertial parameters and the past determined values of the state data are extracted from the memory, which values will be used in the predicting sub-step.

5. The method as claimed in claim 1, wherein the prediction model formed in the data-processing step is based on one of the following elements: a regression, a neural network.

6. The method as claimed in claim 1, wherein the inertial parameters comprise at least certain of the following parameters: one or more linear accelerations, one or more angular velocities.

7. The method as claimed in claim 1, wherein the state data comprises at least certain of the following data of the robot: one or more joint positions, one or more joint velocities, one or more Cartesian positions, one or more Cartesian velocities.

8. The method as claimed in claim 1, wherein it also comprises a programming step in which the robot is programmed to execute said robot path in such a way that the tool follows the smooth path.

9. A system for increasing the accuracy with which a smooth path is followed by a tool of a multi-joint robot, comprising:
the robot which is controlled to execute a path called the robot path allowing the tool to follow a given smooth path, the robot being controlled to execute the robot path for a non-operational situation and for an operational situation of the tool;
at least one inertial measurement device configured to measure the values of inertial parameters during execution of the robot path by the robot, at least for a non-operational situation of the tool;
at least one memory configured to store the values of the inertial parameters measured by the inertial measurement device, and determined values of state data of the robot;
a computing device configured at least to form, based on the measured and stored values of the inertial parameters, on the determined and stored values of the state data, and on the given smooth path, a prediction model for predicting future values of the state data of the robot; and
actuators of the tool that are configured to compensate, during execution of the robot path in the operational situation of the tool, for Cartesian errors in order to increase the accuracy with which said smooth path is followed by the tool, said Cartesian errors being determined based on a predicted Cartesian path, obtained from said future values of the state data.
